(19) United States
(12) Patent Application Publication
(10) Pub. No.: US 2026/0027747 A1
(43) Pub. Date: Jan. 29, 2026

(54) MACHINING DEVICE AND METHOD FOR MACHINING A WORKPIECE

(71) Applicant: HOMAG GmbH, Schopfloch (DE)

(72) Inventor: Tim HAMANN, Dornstetten (DE)

(21) Appl. No.: 19/117,896

(22) PCT Filed: Oct. 2, 2023
(86) PCT No.: PCT/EP2023/077223

§ 371 Date: Apr. 2, 2025

(30) Foreign Application Priority Data
Oct. 4, 2022 (DE) 10 2022 125 511.5

(51) Int. Cl. B27D 5/00

(52) U.S. Cl. CPC B27D 5/006

(57) ABSTRACT

A machining device (10) for machining a workpiece (11) that preferably consists at least in parts of wood, wood materials, plastic or the like, comprising at least one machining unit (13, 14) with a tool device (21) for machining the workpiece (11), a sensor device (15) for contactless detection of a surface (16) of the workpiece (11) to be machined, wherein the tool device (21) can be controlled to carry out a machining operation based on a detection result of the sensor device (15).

### TECHNICAL FIELD

The invention relates to a machining device and a method for machining a workpiece that preferably consists at least in parts of wood, wood materials, plastic or the like.

### PRIOR ART

Processing machines, in particular wood processing machines, can be configured as stationary processing machines or as throughfeed machines, and in both variants, a machining tool and a workpiece are moved relative to one another to carry out a machining operation.

In order to provide a guide for the machining tool during the machining operation, a sensing device is assigned to the machining tool, which rests on the surface of the workpiece during movement of the machining tool and/or the workpiece, thus ensuring a constant distance between the machining tool and the workpiece.

Contact between the sensing device and the workpiece may cause damage that can impair the quality of the workpiece, in particular in the case of sensitive workpiece surfaces such as coating materials. Furthermore, such a mechanical sensing device requires additional installation space in the processing machine.

### DESCRIPTION OF THE INVENTION

The invention is based on the object of providing a machining device that has a simplified structure and enables lower costs. The invention is furthermore based on the object of providing a method that enables high machining quality when machining workpieces.

This object is solved by a machining device according to claim 1 and a method for machining a workpiece according to claim 11. The sub-claims relate to specific embodiments.

The idea forming the basis for the invention is to replace the previously required contact-type sensing devices with contactless sensing. During a machining operation, i.e. during a relative movement between the tool device, in particular the multi-profile tool and/or the tool changing device, and the workpiece to be machined, the tool device, in particular the multi-profile tool and/or the tool changing device, can thus be controlled in a contactless manner based on the detection result of the sensor device. A mechanical sensing device, such as sensing rollers or sensing pads, for mechanical guidance of the machining unit during the machining operation can therefore be dispensed with. In addition to precise machining, this results in a simplified structure and also a smaller space requirement.

Owing to the provision of the sensor device, positioning of the tool device, in particular the multi-profile tool and/or the tool changing device, relative to the surface of the workpiece to be machined can be controlled in a contactless manner based on the detection result in order to carry out the machining operation.

The tool may be configured, for example, as a material-removing machining tool, in particular as a milling tool or cutting tool.

According to a preferred embodiment, it is provided that the tool comprises a multi-profile tool and/or a tool changing device.

The multi-profile tool may in particular be configured for machining a workpiece surface, a workpiece edge and/or a narrow surface of the workpiece. The multi-profile tool may preferably enable the multi-profile machining of a workpiece edge, for example a circumferential workpiece edge, in particular a circumferential edge delimiting the narrow surface of a plate-shaped workpiece.

The tool changing device is preferably configured to receive different machining tools. Different machining operations can be performed with the respective machining tools, in particular for machining the workpiece surface, the workpiece edge and/or the narrow surface of the workpiece. The receivable machining tools may preferably be milling tools, cutting tools such as scrapers and/or saws, etc.

In a further development of the machining unit, the sensor device may comprise at least one distance sensor, at least one camera and/or the like, and may be configured to detect a distance to the surface and/or a contour of the surface of the workpiece. The detection result can be transmitted to the control device.

The at least one distance sensor may be formed, for example, by a laser device for distance measurement. A plurality of distance sensors may preferably be arranged such that a spatial distance measurement to the surface of the workpiece is provided.

If the sensor device comprises at least one camera, the distance to the surface of the workpiece and/or the contour of the workpiece, i.e. a shape of the workpiece surface, workpiece edge and/or narrow surface to be machined, can be determined from the image information. A plurality of cameras may preferably be arranged such that a spatial detection of the contour of the surface of the workpiece is provided.

In this way, the tool device, in particular the multi-profile tool and/or the tool changing device, can be controlled based on the detection result of the sensor device, i.e. based on the determined distance to the workpiece surface and/or the determined contour of the workpiece surface.

A further embodiment of the machining unit may provide that the sensor device is arranged upstream of the tool device, in particular the multi-profile tool and/or the tool changing device, in a machining direction.

In this way, detection of the distance and/or the contour can take place during the relative movement between the machining unit and the workpiece. This enables precise and direct control of the tool device, in particular the multi-profile tool and/or the tool changing device, preferably in real time, based on the detection result of the sensor device.

It is furthermore also possible to provide a sensor device downstream of the tool device in a machining direction, for example for quality monitoring.

In may preferably be provided in the machining unit that the tool device, in particular the multi-profile tool, comprises a machining tool with a first machining profile and at least one further machining profile.

By means of such a tool device or such a multi-profile tool, machining of the workpiece can be carried out by the various machining profiles, i.e. by a defined machining profile, depending on the positioning of the tool device/multi-profile tool relative to the workpiece surface to be machined. Positioning of the defined machining profile of the tool device/multi-profile tool relative to the workpiece is in particular carried out based on the detection result of the sensor device.

The machining tool is in particular a material-removing machining tool, preferably a milling tool with at least two different milling profiles, a scraper with at least two different cutting profiles or the like. The milling profiles of the milling tool or the cutting profiles of the scraper may be formed, for example, by different milling or cutting radii or milling or cutting chamfers for machining workpiece edges.

In a further development of the machining unit, the tool device, in particular the multi-profile tool, may comprise a first machining tool with a first machining profile and at least one further machining tool with a further machining profile, and preferably at least one of the machining tools may be movable between an operating position and a rest position.

With such a tool device or such a multi-profile tool, the workpiece, in particular the workpiece edges, can be machined with different machining profiles, for example different radii or chamfers or protrusions. The machining tools are in particular material-removing machining tools, preferably milling tools with different milling profiles. Machining by the different machining profiles is achieved in that the at least one further machining tool is axially moveable relative to the first machining tool such that in the operating position, the machining profile of the at least one further machining tool is superimposed on the machining profile of the first machining tool for the machining operation.

Positioning of the multi-profile tool and/or control of the axial positioning movement of the at least one further machining tool relative to the first machining tool, i.e. control of the axial positioning movement of the machining tool from the rest position to the operating position, can be provided based on the detection result of the sensor device.

A further embodiment of the machining unit may furthermore provide that the tool changing unit is configured to simultaneously or alternately receive at least two machining tools with different machining profiles and to carry out the machining operation using in each case one of the machining tools.

The tool changing unit is in particular configured to receive various material-removing machining tools with different machining profiles, for example various milling tools, cutting tools or the like. The tool changing unit may, for example, comprise a simple changing unit or a turret device, by means of which the machining tools can be received simultaneously or alternately. The tool changing unit may furthermore be configured such that it can also receive other machining tools, such as drilling or sawing tools.

A control device may advantageously be provided in the machining unit, which is configured to, based on the detection result of the sensor device, transfer the tool device, in particular the multi-profile tool and/or the tool changing unit, into a target position and control the machining operation by the first machining profile or the at least one further machining profile.

The control device may comprise an electronic controller and/or a positioning device, wherein a positioning movement of the tool device, in particular the multi-profile tool and/or the tool changing unit, can be carried out by the positioning device in an X direction and/or a Y direction and/or a Z direction relative to the workpiece, and the positioning movement can be controlled by the electronic controller based on the detection result. The target position is preferably a position of the tool device, in particular the multi-profile tool and/or the tool changing unit, relative to the workpiece, in which machining of the workpiece by a defined machining profile is provided at a defined distance.

Particularly preferably, the control device of the machining unit may be configured to control the tool device, in particular the multi-profile tool and/or the tool changing unit, such that, based on the detection result, a defined machining tool and/or machining profile is selected and transferred into the target position and/or the defined machining tool and/or machining profile is kept at a target distance to the surface of the workpiece during the machining operation.

By means of such a control, the machining operation by the various machining tools and/or various machining profiles can in particular be controlled in an automated manner. As control takes place based on the detection result, precise positioning of the respective machining tool or machining profile relative to the surface of the workpiece to be machined can be controlled.

According to the embodiments described above, the tool may be configured as a multi-profile tool and/or as a tool changing device. However, according to further modifications, it is possible for the tool to comprise a pressing device (such as a pressure roller), an adhesive application device (such as a glue roller), a finishing tool, in particular a scraper, and/or a milling tool, in particular for contour milling or form milling.

The machining device according to the invention may be configured, for example, as a stationary machine tool, in which the workpiece is held in a stationary manner and the machining unit can be moved relative to the workpiece by the conveying device, in particular a multi-axis positioning device, in order to carry out a machining operation. The machining device may be configured as a CNC-controlled processing machine or a CNC-controlled machining centre. The machining device may also be configured as a throughfeed machine, in which the workpiece is moved in a conveying direction relative to the machining unit by the conveying device.

The object is furthermore solved by a method for machining a workpiece that preferably consists at least in parts of wood, wood materials, plastic or the like, according to claim 11.

A high machining quality when machining workpieces using the tool device, in particular the multi-profile tool and/or the tool changing device, can be achieved by means of such a machining method. As the tool device, in particular the multi-profile tool and/or the tool changing unit, is controlled based on the detection result of the sensor device, it can be kept at a defined target distance to the workpiece surface to be machined during the machining operation. Damage to the surface of the workpiece, for example to a sensitive workpiece material or a surface coating, which can be caused by contact between a mechanical sensing device and the workpiece surface, can be prevented due to the contactless detection of the surface of the workpiece by the sensor device.

By detecting the actual position of the surface of the workpiece and controlling the workpiece and/or the machining unit into the target position, precise control of the machining operation can also be achieved, resulting in high machining quality.

Control of the tool device, in particular the multi-profile tool and/or the tool changing unit, of the machining unit based on the detection result furthermore enables a defined machining profile of the tool device, in particular the multi-profile tool and/or the tool changing unit, to be selected and positioned relative to the workpiece surface to be machined in order to carry out the machining operation using this defined machining profile.

### BRIEF DESCRIPTION OF THE DRAWINGS

Further features and advantages of a device, a use and/or a method are apparent from the following description of embodiments with reference to the accompanying drawings. These figures show the following:

FIG. 1 a schematic perspective view of an embodiment of a machining device according to the disclosure;

FIG. 2 a schematic view of an example of a multi-profile tool;

FIG. 3 a schematic view of an alternative example of a multi-profile tool;

FIG. 4 a schematic perspective view of a second embodiment of a machining device according to the disclosure.

### DESCRIPTION OF EMBODIMENTS

Identical reference numbers used in different figures designate identical, corresponding or functionally similar elements.

FIG. 1 shows a schematic perspective view of an embodiment of a machining device 10 according to the invention for machining workpieces 11.

The machining device 10 is in particular a throughfeed machine, in which a workpiece is moved relative to one or more machining units.

The machining device 10 comprises a conveying device 12, which, according to FIG. 1, is configured as a continuous conveying device, for example a conveyor belt, a conveyor chain, a transport belt or the like. The workpiece 11 to be machined is positioned on the conveying device 12 and is moved in a conveying direction F relative to one or more machining units 13, 14. During a machining operation, the workpiece 11 can be moved in the conveying direction F by the one or more machining units 13, 14.

In an alternative embodiment of the machining device 10, it may also be provided that the workpiece 11 rests stationary on a workpiece support and that the one or more machining units 13, 14 are moved relative to the workpiece 11 by the conveying device 12, in particular by a positioning device.

Mixed forms of these two concepts are also possible, with the conveying device 12 having the task of bringing about a relative movement between the workpiece 11 and the one or more machining units 13, 14.

The machining device 10 can therefore be configured both as a throughfeed machine and as a stationary processing machine.

The workpiece 11 to be machined is in particular a workpiece formed at least in parts of wood, wood materials, plastic or the like. The workpiece 11 may be a plate-shaped workpiece. The workpieces may preferably be different workpieces 11, for example solid wood boards or chipboard, lightweight boards, sandwich boards, profiles or the like. The present invention is, however, not limited to such workpieces 11.

According to FIG. 1, the machining device 10 comprises two machining units 13 and 14, each of which carries out a machining operation on the workpiece 11. The machining device 10 may also comprise only one machining unit 13 or 14 or more than two machining units.

The machining device 10 furthermore comprises a sensor device 15 for contactless detection of a surface 16 of the workpiece 11 to be machined.

The sensor device 15 may preferably be provided separately from the machining units 13, 14 in the machining device 10. The sensor device 15 may also be arranged on one or both machining units 13, 14 or be configured integrally with the machining units 13 and/or 14.

The sensor device 15 comprises two distance sensors 17, 18, which are configured, for example, as laser sensors or line sensors for distance measurement.

Additionally or alternatively, the sensor device 15 may comprise one or more cameras to optically detect a distance to the surface 16 and/or to detect a contour of the surface 16 of the workpiece 11, for example a workpiece edge, a narrow surface of the workpiece or the like.

In this way, a spatial distance to the surface 16 of the workpiece 11 can be measured and/or a shape of the surface 16 to be machined, i.e. the edge of the workpiece, the narrow surface or the like, can be determined by the sensor device 15 based on the distance and/or image information.

The sensor device 15 forms a contactless sensing device for the machining units 13, 14. An actual position of the surface 16 of the workpiece 11 to be machined can be determined based on a detection result of the sensor device 15.

The data detected by the sensor device 15 regarding the surface 16 of the workpiece 11 to be machined, i.e. the detection result of the sensor device 15, is transmitted to a control device 19 that controls the machining units 13, 14 to each carry out the machining operation based on the detection result.

The control device 19 may comprise an electronic controller and a positioning device 20. By means of the positioning device 20, a positioning movement of the machining units 13, 14 can be carried out in an X direction, a Y direction and/or a Z direction. The positioning movement can be controlled by the electronic controller of the control device 19 based on the detection result of the sensor device 15.

By means of the control device 19, the machining units 13, 14 can be controlled between an actual position and a target position for machining the surface 15 of the workpiece 11. In the target position, the machining units 13, 14 are in particular positioned at a defined target distance to the surface 16 of the workpiece 11 during the machining operation.

The machining units 13, 14 each comprise a unit base body that can be coupled to the machining device 10, for example to a drive device of the machining device 10, via an interface device that is not shown in more detail.

A machining unit 13, 14 comprises a tool device, in this case in particular a multi-profile tool 21 or a tool changing device, in order to carry out a machining operation on the workpiece 11. The two machining units 13, 14 may each have different multi-profile tools 21 or tool changing devices. It may also be provided that one machining unit 13 comprises a multi-profile tool 21 and the other machining unit 14 comprises a tool changing device.

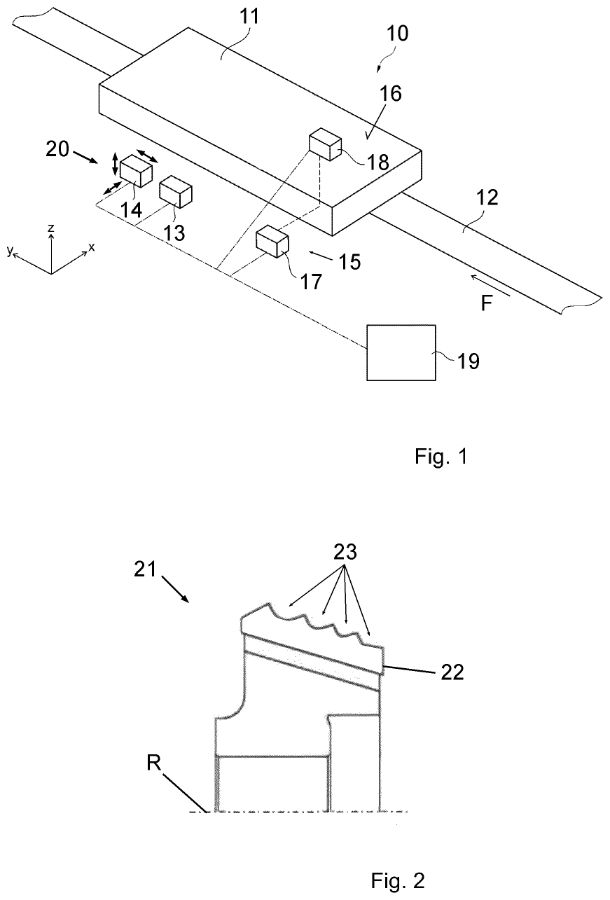

FIG. 2 shows a schematic view of a first embodiment of a multi-profile tool 21.

This multi-profile tool 21 is formed by a machining tool 22 that has a plurality of machining profiles 23 for machining the workpiece 11.

The machining profiles 23 are preferably configured for machining the edge of the workpiece 11. The machining tool 21 is in particular a milling tool having different milling radii or milling chamfers for machining the workpiece 11, in particular for machining the edge of the workpiece 11. The machining tool 21 may form a rotationally symmetrical body and rotate about an axis of rotation R.

The multi-profile tool 21 can be coupled to a drive shaft of the machining device 10, which is not shown in more detail, via the interface device such that a torque can be applied to the machining tool 22.

The machining tool 21 may also be configured as a cutting tool or a scraper, which has different cutting radii or cutting chamfers for machining the workpiece 11, in particular for machining the edge of the workpiece 11.

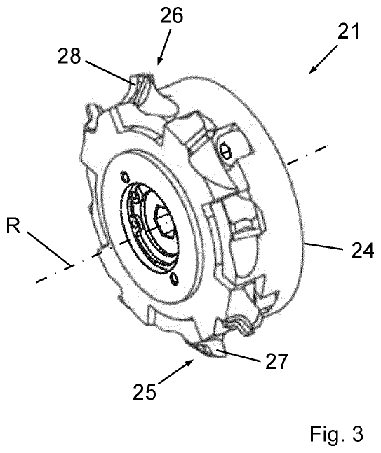

FIG. 3 shows an alternative embodiment of a multi-profile tool 21.

This multi-profile tool 21 comprises a base body 24 with a first machining tool 25 and a second machining tool 26. The two machining tools 25, 26 are arranged coaxially to one another and so as to be rotatable about a common axis of rotation R.

The multi-profile tool 21 can be coupled to the drive shaft of the machining device 10 via the interface device such that a torque can be applied to the first machining tool 25 and/or the second machining tool 26.

The second machining tool 26 is provided on an outer periphery of the first machining tool 25 so as to be axially displaceable relative to the first machining tool 25, such that the second machining tool 26 is axially displaceable between a rest position and an operating position.

The first machining tool 25 forms a first machining profile 27 at one end face of the multi-profile tool 21. The second machining tool 26 forms a second machining profile 28 at the end face in the operating position. By axially displacing the second machining tool 26 relative to the first machining tool 25, the second machining profile 28 of the second machining tool 26 is superimposed on the first machining profile 27 of the first machining tool 25 such that two different machining profiles 27, 28 for machining the workpiece 11 are provided by the multi-profile tool 21.

The first and second machining tools 25, 26 are in particular each milling tools with different milling radii or milling chamfers for machining the edge of the workpiece 11.

As described above, the control device 19 is configured to transfer the machining units 13, 14 from the actual position into the target position for machining the surface 15 of the workpiece 11 based on the detection result of the sensor device 15.

The control device 19 is in particular configured to move the respective machining tool 22, 25, 26, with which the machining operation is to be carried out, into the target position during the machining operation at a constant distance to the surface 16 of the workpiece 11 to be machined.

The control device 19 is furthermore preferably configured to position the respective machining tool 22, 25, 26 in the target position relative to the surface 16 of the workpiece 11 to be machined such that the machining operation can be carried out with a defined machining profile 23, 27, 28.

The control device 19 may furthermore be configured to, based on the detection result of the sensor device 15, select a defined machining profile 23, 27, 28 and position the machining tool 22, 25, 26 with this defined machining profile 23, 27, 28 relative to the surface 16 of the workpiece 11 in order to carry out the machining operation.

If the machining unit 13, 14 comprises a tool changing device, the control device 19 may be configured to control the tool changing unit such that based on the detection result, a defined machining tool is selected, for example is swapped in by the tool changing device, and this tool is transferred to the target position in order to carry out the machining operation.

By means of such a control by the control device 19, automated control of the machining operation by the various machining profiles 23, 27, 28 and/or machining tools can be provided based on the detection result.

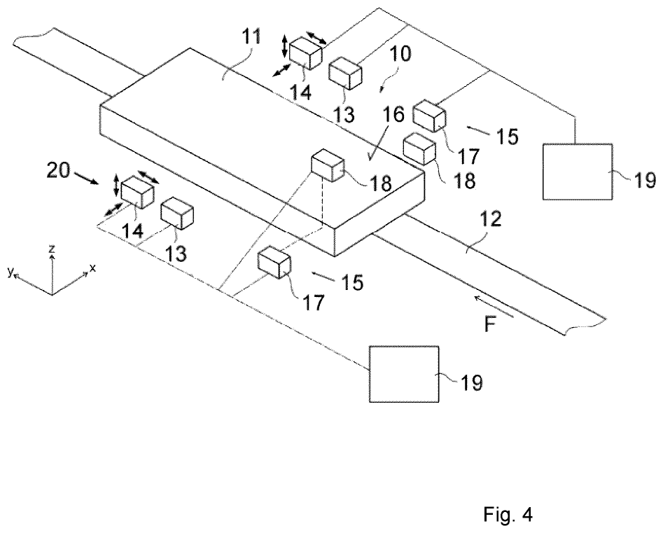

FIG. 4 shows a second embodiment of a machining device 10 according to the disclosure for machining workpieces 11.

The second embodiment primarily differs from the first embodiment described with reference to FIG. 1 in that a further surface of a workpiece 11 can be sensed and machined. For the following explanation of the second embodiment, reference is therefore also made to the description of the first embodiment in order to avoid repetition, in particular also to the description of the previously described modifications of certain features.

As in the first embodiment, the machining device 10 comprises a conveying device 12. The workpiece 11 to be machined is positioned on the conveying device 12 and is moved in a conveying direction F relative to one or more machining units 13, 14.

The machining device 10 comprises two machining units 13 and 14 on a right-hand side (in the throughfeed direction) and two machining units 13 and 14 on a left-hand side (in the throughfeed direction).

The machining device 10 furthermore comprises two sensor devices 15 (one sensor device 15 being arranged on the left and one on the right in the throughfeed direction) for contactless detection of a surface 16 of the workpiece 11 to be machined. The sensor devices 15 may be provided separately from the machining units 13, 14 in the machining device 10. The sensor devices 15 may also be arranged on one or both machining units 13, 14 or be configured integrally with the machining units 13 and/or 14.

Each of the sensor devices 15 comprises two distance sensors 17, 18, which are configured, for example, as laser sensors or line sensors for distance measurement. Additionally or alternatively, the sensor devices 15 may comprise one or more cameras to optically detect a distance to the surface 16 and/or to detect a contour of the surface 16 of the workpiece 11, for example a workpiece edge, a narrow surface of the workpiece or the like.

In this way, a spatial distance to the surface 16 of the workpiece 11 can be measured and/or a shape of the surface 16 to be machined, i.e. the edge of the workpiece, the narrow surface or the like, can be determined by the respective sensor device 15 based on the distance and/or image information.

The sensor devices 15 each form a contactless sensing device for the machining units 13, 14. An actual position of the surface 16 of the workpiece 11 to be machined can be determined based on a detection result of the sensor device 15.

The data detected by the sensor devices 15 regarding the surface 16 of the workpiece 11 to be machined, i.e. the detection result of the sensor device 15, is transmitted to a control device 19 that controls the machining units 13, 14 to each carry out the machining operation based on the detection result.

In FIG. 4, the control device 19 is clearly illustrated by two separate areas. However, instead of one control device 19, separate control devices may also be provided.

As regards further aspects, reference is made to the explanations provided with respect to the first embodiment. The same applies as regards the details of the tool device 21, whereby according to the second embodiment, a plurality of tool devices 21 are or may be provided.

It is apparent to the person skilled in the art that individual features described in different embodiments may also be implemented in a single embodiment, provided that they are not structurally incompatible. Similarly, various features described in the context of a single embodiment may also be provided in several embodiments either individually or in any suitable sub-combination.

1. A machining device (10) for machining a workpiece (11) that preferably consists at least in parts of wood, wood materials, plastic or the like, comprising:
at least one machining unit (13, 14) with a tool device (21) for machining the workpiece (11),
a sensor device (15) for contactless detection of a surface (16) of the workpiece (11) to be machined, wherein
the tool device (21) can be controlled to carry out a machining operation based on a detection result of the sensor device (15).

2. The machining device according to claim 1, wherein the tool device comprises a multi-profile tool (21) and/or a tool changing device.

3. The machining device according to claim 1, wherein the sensor device (15) is configured to detect a distance to the surface (16) and/or a contour of the surface (16) of the workpiece (11), and preferably comprises at least one distance sensor (17, 18) and/or at least one camera.

4. The machining device according to claim 1, wherein the sensor device (15) is arranged upstream of the tool device in a machining direction.

5. The machining device according to claim 1, wherein the tool device (21) comprises a machining tool (22) with a first machining profile (23) and at least one further machining profile (23).

6. The machining device according to claim 1, wherein the tool device (21) comprises a first machining tool (25) with a first machining profile (27) and at least one further machining tool (26) with a further machining profile (28), and preferably at least one of the machining tools (25, 26) is moveable between an operating position and a rest position.

7. The machining device according to claim 2, wherein the tool changing unit is configured to simultaneously or alternately receive at least two machining tools with different machining profiles and to carry out the machining operation using in each case one of the machining tools.

8. The machining device according to claim 5, wherein a control device (19) is furthermore provided, which is configured to, based on the detection result of the sensor device (15), transfer the tool device (21) into a target position and control the machining operation by the first machining profile (23, 27) or the at least one further machining profile (23, 28).

9. The machining device according to claim 8, wherein the control device (19) is configured to control the tool device (21) such that, based on the detection result, a defined machining tool (22, 25, 26) and/or machining profile (23, 27, 28) is selected and transferred into the target position and/or the defined machining tool (22, 25, 26) and/or machining profile (23, 27, 28) is kept at a target distance to the surface (16) of the workpiece (11) during the machining operation.

10. The machining device according to claim 1, wherein the tool device comprises a pressing device, an adhesive application device, a scraper and/or a milling tool, in particular for contour milling or form milling.

11. A method for machining a workpiece (11) that preferably consists at least in parts of wood, wood materials, plastic or the like, in particular using a machining device (10) according to claim 1, comprising the steps of:
contactlessly detecting a surface (16) of the workpiece (11) by means of a sensor device (15),
determining an actual position of the surface (16) of the workpiece (11) based on a detection result of the sensor device (15), and
controlling the workpiece (11) and/or the machining unit (13, 14) into a target position in order to carry out a machining operation on the workpiece (11), wherein
a tool device (21) is controlled based on the detection result such that the machining operation is carried out by a first machining profile (23, 27) or by at least one further machining profile (23, 28) of the tool device (21).
